(19) United States
(12) Patent Application Publication
(10) Pub. No.: US 2014/0367532 A1
(43) Pub. Date: Dec. 18, 2014

(54) CLAMP FOR CLAMPING A PIPE OR CONDUIT TO A RIGID BARRIER

(71) Applicant: SAMUEL E. CICHON, Fishkill, NY (US)

(72) Inventor: SAMUEL E. CICHON, Fishkill, NY (US)

(21) Appl. No.: 14/458,302

(22) Filed: Aug. 13, 2014

Related U.S. Application Data
(62) Division of application No. 13/400,276, filed on Feb. 20, 2012.

(51) Int. Cl. F16L 5/00

(52) U.S. Cl. CPC F16L 5/00
USPC 248/74.1

(57) ABSTRACT

A method of clamping a conduit comprising a cylindrical conduit (tube or pipe) to an aperture in a rigid barrier by steps of providing a clamp with a wide plate with a peripheral flange on an obverse end and a narrower boss back surface on an opposite end and with a central hole extending through the plate and the boss, and with a radial slot extending outwardly from a central hole to peripheral edges of both the plate and the boss. The clamp is installed onto a pipe or conduit by inserting a wedge into the radial slot; sliding the clamp onto the tube pipe until it is in contact with a rigid barrier; affixing the clamp to the rigid barrier with adhesive or fasteners; and removing the wedge from the radial slot.

This application is a division of application Ser. No. 13/400,276 filed Feb. 20, 2012.

### BACKGROUND OF THE INVENTION

The present invention relates to a method for clamping a conduit to a barrier, with the conduit comprising a tube or a pipe and the barrier comprising a rigid support structure. This invention relates more particularly to clamps for rigidly securing a conduit to a barrier through which it passes; and methods of clamping the conduit to the barrier.

When a conduit in the form of a tube, a pipe for plumbing or an electrical conduit is inserted through a hole drilled or cut through a barrier, e.g. a rigid support structure, a wall, a bulkhead, etc., for attachment to a fixture, there is a problem. The problem is how to secure the conduit in a fixed position relative to the barrier so that it is prevented from sliding in and out through the hole or twist laterally, vertically or at an angle in response to a force exerted upon the fixture attached to the pipe or tube. For example in the case of a plumbing fixture such as a shower head or service valve which is attached to a pipe extending through a hole in a wall, it is important to affix the pipe in position to prevent the shower head from moving in and/or out through the hole in the wall or twisting at an angle after installation of the plumbing fixture is completed. In addition, in the case of a number of plumbing fixtures such as shower heads and the like, an escutcheon plate comprising a decorative plate is provided to surround the pipe on the exterior of the wall through which the pipe extends. For example escutcheon plates are provided behind a plumbing fixture such as a faucet in a bathtub or a shower. There is the additional problem in that case which is that the device which secures the conduit in position must be able to be hidden behind the thin escutcheon plate supplied with the plumbing fixture.

I have also found that it is necessary to clamp a conduit such as a pipe or tube which passes through a barrier (rigid support) such as a wall, bulkhead, floor, ceiling, cabinet, fence, etc. to hold fixtures in a fixed position.

I have also found that to maintain the desired esthetic appearance of a plumbing installation, it is often advantageous to employ a thin invisible escutcheon clamp in accordance with this invention which secures the pipe in a fixed position, but which can be hidden behind an escutcheon plate. The escutcheon plates provided by the manufacturer of the plumbing fixture are usually shallow. Thus, in order for a pipe clamp to be hidden from view, I have found that it is desirable to supply an invisible escutcheon clamp which is thin enough to fit behind such a shallow escutcheon plate. At the same time, such a shallow pipe clamp must provide a rigid clamping force that will prevent sliding of the pipe in and out of the barrier, wall or bulkhead. I have also sound that various types of clamps need to be provided with individual characteristics suitable for diverse applications.

Moreover there is a need for various routines (i.e. sequences of method steps) for installation of a clamp for affixing a conduit to a barrier.

In the case of new construction where a clamp is needed for installation of a conduit through a wall, one set of routine steps is required for cold installations of plastic or iron clamps.

In another case of new construction a modified routine is required for installation of a conduit through a wall, for cold installations of plastic or iron clamps for a utility fixture.

In still another case of new construction a modified routine is required for installation of a conduit through a floor or ceiling, for cold installations of plastic or iron clamps for a utility fixture.

In the case of a utility-copper hot installation for new construction a modified routine is required for installation of a conduit for hot installations of a stamped metal conduit clamp for a utility fixture.

In the case of a repair application where a clamp is needed for installation of a conduit through a finished wall, one set of routine steps is required for cold installations of plastic or iron clamps.

In another repair application a modified set of routine steps is required for installation of a conduit through a wall, for cold installations of plastic or iron clamps for a utility fixture.

In yet another repair application a modified routine steps is required for installation of a conduit through a floor or ceiling, for cold installations of plastic or iron clamps for a utility fixture.

In the case of a utility-copper hot installation for a repair application a modified routine is required for installation of a conduit for hot installations of a stamped metal conduit clamp for a utility fixture.

Glossary This glossary indicates the intended definitions and interpretations of several terms employed herein.
Barrier: A rigid support structure: a wall, bulkhead, floor, ceiling, cabinet, fence, etc.
Tube Clamp: A tube clamp includes a clamp plate with a clamp boss (17), both
   having a radial slot and a cylindrical tube hole therethrough, for clamping a cylindrical tube (pipe.) The clamp plate has a large radius flange (collar) with the narrow radius clamp boss formed on the front or rear of the tube clamp flange.
Clamp plate: A thin relatively flat plate with a radial slot and a cylindrical opening through it with a clamp flange, a disk or a polygon, on the margin of the tube clamp.
Elastic modulus: The elastic modulus (modulus of elasticity) indicates how much an elastic material deforms temporarily when a force is applied thereto.
Escutcheon: A decorative trim shield with a flange composed of metal or plastic
   for installation behind, above, or beneath a fixture such as a faucet or hose bib that covers the conduit connected to a faucet and the hole through which that pipe extends out through a barrier to the fixture.
Tube Clamp flange: The tube clamp flange, that affixes the tube clamp to a barrier, is in the shape of a collar or base on the outer edge of the clamp plate extending beyond the outer surface of the boss. It may have an adhesive surface or fastener holes through it to fasten the clamp to a barrier with fasteners, etc.
Hose bib: a hose bib (aka hose bibb) is a threaded faucet or service valve (aka wall hydrant,) e.g. a standard exterior or laundry faucet.
Rigid support structure: A barrier such as a wall, bulkhead, floor, ceiling, sink,
   fence, post or cabinet through which a tube hole is formed or is to be formed through which a conduit can or will extend.

In accordance with this invention a method is provided including steps for clamping a conduit to a barrier with the conduit passing through a barrier hole through the barrier. The conduit may comprise a cylindrical tube or pipe. The steps include providing a clamp with a plate with a peripheral flange on an obverse end and preferably including a boss on an opposite end, with a central hole extending through the clamp from one end to the other, and with a radial slot extending outwardly from the central hole to peripheral edges of the entire clamp. Additional steps include inserting a wedge into the radial slot; moving the clamp into contact with the rigid barrier; affixing the clamp to the rigid barrier with adhesive or fasteners; and removing the wedge from the radial slot.

Further steps in accordance with the method of this invention include in the case of a new installation forming the barrier hole through the barrier for the installation; then inserting the conduit through the barrier hole; then inserting the wedge into the radial slot; then either exposing adhesive on the flange or applying adhesive thereto; then installing the clamp with adhesive or fasteners bonding the clamp to the barrier; then removing the wedge from the radial slot; then installing a fixture on the conduit; and then turning on the utility. Preferably the boss behind the plate is inserted into the barrier hole through the barrier.

In the case of a repair, further steps in accordance with the method of this invention include first turning off a utility connected to a conduit; then removing a fixture from the conduit; then inserting the wedge into the radial slot; then either exposing adhesive on the flange or applying adhesive thereto; then installing the clamp with the adhesive bonding the clamp to the barrier; then removing the wedge from the radial slot; then installing a fixture on the conduit; and then turning on the utility. Preferably the boss behind the plate is inserted into the barrier hole through the barrier.

An additional optional set of steps in accordance with this invention include forming fastener holes when required by placing the clamp in the barrier hole, marking sites for holes and installing anchors in the barrier; and later aligning the clamp with the holes and inserting fasteners in the anchors and tightening the fasteners.

Another optional step in accordance with this invention is to slide an escutcheon ring over the conduit before installing the fixture on the conduit.

In accordance with another aspect of this invention, a clamp for supporting a cylindrical conduit, such as a tube or pipe, passing through a barrier. The clamp includes a clamp plate with a clamp having obverse and reverse clamp surfaces. Preferably the clamp includes a boss on one of the clamp surfaces and a flange on the outer margin of the clamp plate. A central hole which is cylindrical extends through the clamp from front to back. The central hole has an Inner Diameter (ID) to accommodate and clamp a conduit of a predetermined Outside Diameter (OD). The clamp includes a radial slot therethrough from front to back extending outwardly from the ID of the central hole to peripheral edges of the clamp. The clamp includes attachment means in the form of adhesives or fasteners for attaching the clamp to a rigid barrier.

Preferably, the clamp plate is thin in order to be positioned behind an escutcheon ring.

Preferably the boss extends the clamp plate into the barrier for a shower head or service valve or away from the barrier for a utility fixture.

Preferably the clamp plate is a round disk or a polygonal.

Preferably the clamp extends from front to back to a thickness sufficient to stabilize a conduit, or a boss is provided which is sufficiently thick to reinforce the stabilization of a conduit.

The invention and objects and features thereof will be more readily apparent from the following detailed description and appended claims when taken with the drawings.

### BRIEF DESCRIPTION OF THE DRAWINGS

FIGS. 1A-1B show views of a bulkhead type of Visible Tube Clamp (VTC) in accordance with this invention inserted into a hole in a rigid support structure such as a bulkhead or wall; and FIGS. 1C-1D show views of a pipe inserted into the bulkhead type of VTC of FIGS. 1A-1B with the VTC secured to the rigid support structure by a fastener and/or by adhesive.

FIGS. 2A-2G show views of a bulkhead type of pipe or tube Visible Tube Clamp (VTC) in accordance with this invention.

FIGS. 3A-3F show an Invisible Escutcheon Clamp (IEC) in accordance with this invention.

FIGS. 4A-4H show a heat resistant plastic or stamped metal version of a Hose Bib Clamp (HBC) for a water pipe connected to a hose bib of this invention.

FIGS. 5A-5H show a square plastic Visible Clamp (VC) for a pipe or tube in accordance with this invention.

FIG. 6 shows a pentagonal VC with a conduit hole therethrough which is pitched at a 30 degree angle for a pipe or tube in accordance with this invention.

FIG. 7 is a flow chart which shows sequences of steps in accordance with the method of this invention of making a new construction installation with the various types of tube clamps tube in accordance with this invention.

FIG. 8 is a flow chart which shows sequences of steps in accordance with the method of this invention of making a repair installation with the various types of tube clamps tube in accordance with this invention.

The following detailed description which follows explains the preferred embodiments of the invention, together with advantages and features, by way of example, with reference to the drawings.

### DETAILED DESCRIPTION OF PREFERRED EMBODIMENTS OF THE INVENTION

### Pipe Clamp for Barriers Such as Walls or Bulkheads

In accordance with this embodiment of the present invention a conduit clamp includes a clamp plate with a peripheral flange and boss on the reverse side with a radial slot in the clamp plate, the flange and the boss comprising a split in the clamp. The clamp is composed of a flexible material such as plastic or a metal stamping that will hold a tubular structure or a pipe by means of tension against the surface of the pipe or tube and the inside surface of the clamp plate boss. The flange is then glued or bolted to the wall or bulkhead that it is passing through to secure the pipe or tube in a permanent position.

### Visible Tube Clamp (VTC)

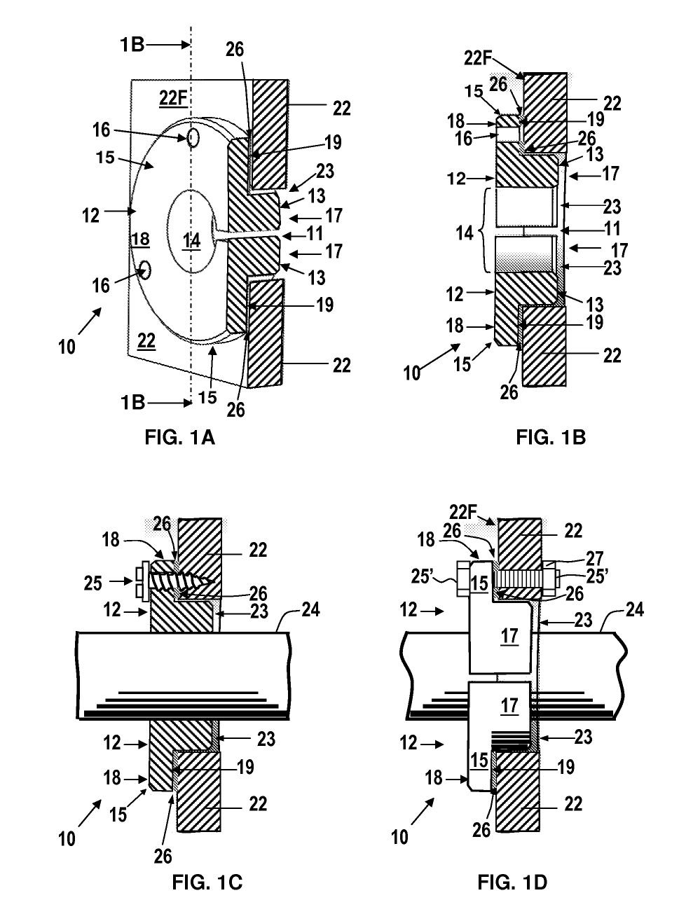

FIGS. 1A and 1B show several different partially-sectioned views of a Visible Tube Clamp (VTC) 10 in accordance with this invention. FIG. 1A is a partially-sectioned, perspective view of the VTC 10 with the section taken along section line 1B-1B in FIG. 1A. The VTC 10 is shown with a boss 17 in the rear thereof inserted into a hole 23 through a barrier 22 which for example is a bulkhead or a wall. A flange 15 on the front of the VTC 10 has a back 19 next to the barrier 22. FIG. 1C shows the VTC 10 of FIG. 1B which is permanently installed in the hole 23 through the barrier 22 by adhesive 26 and screw 25 in FIG. 1C or by a bolt 25′. A conduit 24 is installed in a conduit hole 14 through the VTC 10. FIG. 1D is a modification of FIG. 1C with the boss 17 shown intact and with adhesive 26 and a screw 25′ assembled with a threaded nut 27 holding the VTC 10 in position.

In more detail, FIG. 1A is a partially-sectioned, perspective view of the VTC 10 which is a round, one piece unit for clamping a tube such as tube 24 shown in FIGS. 1C and 1D. The VTC 10 is shown inserted into the clamp hole 23 through a partially-sectioned barrier 22 which such as a wall or a bulkhead. In FIG. 1A the front of the VTC 10 comprises a flat, thin, wide cylindrical clamp plate 12. Behind the clamp plate 12 is a narrower, round boss 17. On the periphery of the clamp plate 12 is a clamp flange 15 with a greater radius than the boss 17. The clamp plate 12 and the boss 17 are hollow in that they have a conduit hole 14 extending from the front to the back of the VTC 10 along the central axis thereof. In other words, the clamp plate 12 is a round disk on the front of the VTC 10. The narrower, yet round boss 17 formed on the back of the VTC 10 is integral with the clamp plate 12. The clamp plate 12 includes the clamp flange (collar) 15 that is coplanar with the front surface of the clamp plate 12 and is formed on the margin thereof. In this embodiment, as shown in FIG. 1A, the clamp flange 15 is beveled on its periphery and the clamp flange 15 has a circular (round) periphery. In this embodiment the clamp boss 17, which is a hollow cylindrical tube, lies behind the clamp plate 12. The boss 17 has a central axis coaxial with the central axis of the clamp plate 12. The conduit hole 14 which is coaxial with the central axis of the clamp plate 12 and boss 17 of the VTC 10 extends from the front of the clamp plate 12 to the back of the boss 17. A radial slot 11 that is formed in one side of the VTC 10 extends from the inside of the conduit hole 14 to the exterior of the tube clamp plate 12 and it also extends to the exterior of the boss 17. The Visible Tube Clamp (VTC) 10 is composed of an elastic material which has a suitable modulus of elasticity for temporarily being deformed but which returns to its normal shape and providing a clamping force when the cause of the deformation force is removed. In accordance with the method of this invention, the clamp hole 23 has been bored or cut through a barrier 22 which comprises a rigid support structure. For purposes of explanation and illustration of features of the VTC 10, FIG. 1A shows clamp 10 (with no pipe inserted therein) inserted into the clamp hole 23 in the barrier 22.

An alternative to the conduit hole 14 being coaxial with the conduit clamp 10, the axis of the conduit hole 14 can be pitched at an angle such as 10, 20 or 30 degrees with respect to the conduit clamp 10 to provide for a conduit which is to slant at an angle such as a pipe to be connected to a shower head or a conduit which needs to connect at an alternative angle to a fixture.

FIG. 1B is a sectioned, side elevation of the VTC 10 taken along section line 1B-1B in FIG. 1A. Flange 15 extends radially from the margin of clamp plate 12 and is juxtaposed with the front wall of the barrier 22. The VTC 10 includes the boss 17 on its back. The radial slot 11 is seen in the clamp plate 12 and the flange 15 on the front of the VTC 10 and the radial slot 11 is seen in the boss 17. The conduit hole 14 extends through the center of the VTC 10 concentric with the clamp plate 12, the clamp flange 15 and the boss 17. The radial slot 11 extends out from the interior of the conduit hole 14 from the front to the back of the VTC 10. Two optional fastener holes 16 extend through the flange 15 from its front surface 18 to its back surface 19 with the holes 16 exposing the surface of the barrier 22 into which a threaded fastener 25 is shown inserted in FIGS. 1C and 1D. The VTC 10 with the radial slot 11 in the split (slotted) clamp plate 12 and with the split (slotted) raised boss 17 is preferably composed of a flexible material such as plastic or a metal stamping that will hold a conduit by means of tension against the surface of the conduit and the inside surfaces of the clamp plate 12 and the boss 17. The back surface 19 of the flange 15 is then glued and/or bolted to a wall or a bulkhead that it is passing through to secure a pipe or a tube in a permanent position as illustrated by pipe 24 in VTC 10 in FIGS. 1C and 1D as described below.

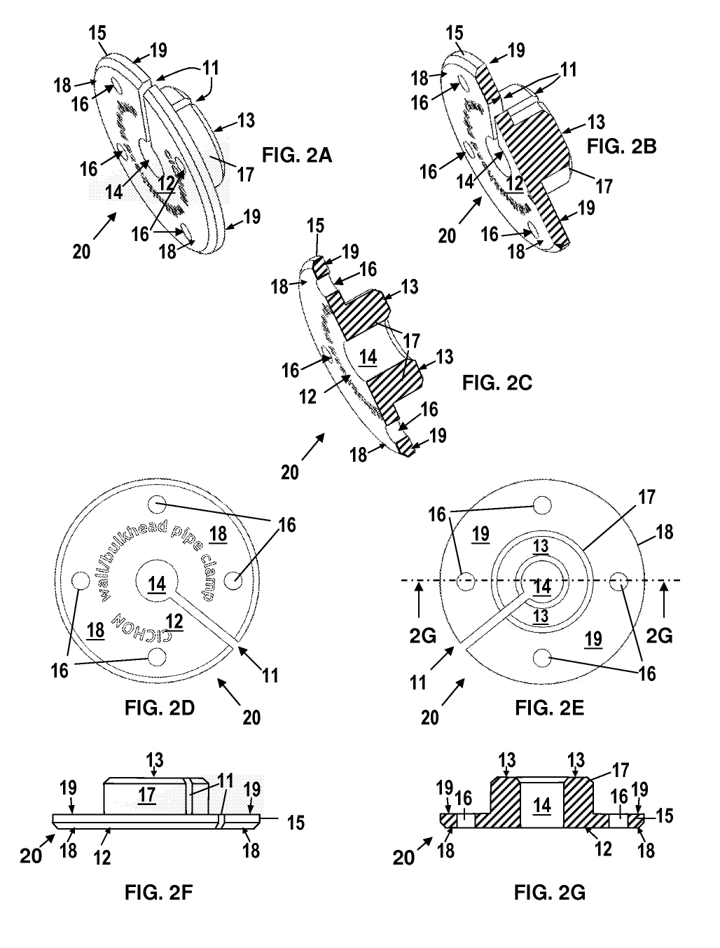

FIGS. 1C and 1D show a pipe 24 inserted into the VTC 10 of FIGS. 1A-1B secured to the rigid support structure 22 by a threaded fastener comprising a screw 25 plus adhesive 26 between the back surface 19 of the flange 15 and the front surface 22F of barrier 22. FIG. 2C is a sectioned elevation which is a modification of FIG. 2B showing a pipe 24 extending through both the bulkhead VTC 10 and the barrier 22 with the pipe 24 clamped into position by the VTC 10. The screw 25 is shown securing the VTC 10 to the barrier 22. The adhesive material 26 which bonds the VTC 10 to the barrier 22 fills the gap between the back 19 of the flange 15 and the confronting surface of the barrier 22. In FIG. 1D, which is a modification of FIG. 1C, the VTC 10 is shown without the sectioning of the clamp plate 12 and the boss 17, showing how the clamp plate 12 and the boss 17 surround the clamped pipe 24.

### Visible Clamp (VC)

FIGS. 2A-2G show views of a Visible Clamp (VC) 20 in accordance with this invention for installation of a conduit through a barrier such as the barrier 22 in FIGS. 1A-1D. The VC 20 is composed of an elastic material with a suitable modulus of elasticity for temporarily being deformed by applying leverage to the radial slot 11, but which returns to its normal shape whereby it provides a clamping force when the leverage is removed ending the deformation. FIG. 2A is a perspective view of the VC 20 which comprises a flat, thin, wide, hollow disk shaped clamp plate 12 in front and a narrower, hollow cylindrical boss 17 in the back, which is integral with the clamp plate 12. As in FIGS. 1A-1D, the clamp plate 12 includes the coplanar round flange 15 on its margin. As shown in FIG. 2A, the boss 17 lies behind the clamp plate 12 and the boss 17 has a central axis coaxial with the central axis of the clamp plate 12. A conduit hole 14, which is coaxial with the central axis of the clamp plate 12 and boss 17 of the VC 20, extends completely through the VC 20 from front the front of the clamp plate 12 to the back of the cylindrical boss 17. The radial slot 11 is formed in the side of the VC 20 reaching out from the conduit hole 14 to the periphery of the clamp plate 12 including the clamp flange 15 and the boss 17. To prepare for insertion of a pipe or tube through the VC 20, a lever pries the radial slot 11 open by exerting strain force on the VC 20. The VC 20 opens to widen the diameter of the tube hole 14 temporarily but the stress force of the VC 20 is sufficient to clamp/affix a pipe or a cylindrical tube in place thereafter.

FIGS. 2B and 2C are partially sectioned, perspective views of the VC 20 of FIG. 2A. FIG. 2B is a sectioned view of FIG. 2A taken through the clamp plate 12 and the boss 17. FIG. 2C is a modification of FIG. 2B with a section taken along the central axis of the VC 20 extending through the center of the conduit hole 14. As shown in FIG. 2A, the boss 17 is cylindrical and coaxial with the wider, thin, cylindrical clamp plate 12. Since the boss 17 has a narrower radius than the clamp plate 12, there is a flat flange 15 on the margin of the clamp plate 12, which extends outwardly beyond the radius of the boss 17 away from the central axis of the clamp 20. The conduit hole 14 extends through the center of the VC 20 concentric with the clamp plate 12, the flange 15 and concentric with the boss 17. In addition, fastener holes 16 for bolts or screws extend through the flange 15 (from its front surface 18 to its back surface 19) for fastening the VC 20 to a hard surface such as a bulkhead, wall, or a floor, etc. as illustrated by FIGS. 1A-1D and as will be described below.

FIG. 2B is a section taken from front to back through a third of the VC 20 with the slot 11 remaining. FIG. 2C is a section taken from front to back through the center of the VC 20. FIG. 2D is a front view of the VC 20 and FIG. 2E is a back view thereof. FIG. 2F is an inverted side view of FIG. 2D. FIG. 2G is a section taken along section line 2G-2G in FIG. 2E.

FIGS. 2A, 2B, 2D-2F show the radial slot 11 extending outwardly from the conduit hole 14 (i.e. from the central axis of the VC 20) through both the clamp plate 12 and the boss 17 to provide access for a lever to wedge the VC 20 partially open temporarily to permit the insertion of a conduit therethrough. The radial slot 11 extends outwardly from the interior of the conduit hole 14. The VC 20 is composed of a material which is moderately stiff but flexible enough to be deformed temporarily to open the conduit hole 14 without damaging the VC 20. In other words, the VC 20 has a modulus of elasticity which permits temporarily increasing the ID of the conduit hole 14 by using a lever to partially open the radial slot 11 in the VC 20 from the front of the clamp plate 12 to the back of the boss 17. As referred to herein, a stiffer material has a higher elastic modulus than a less stiff material. A lever (not shown) exerts strain force to open the VC 20 when that lever is inserted into the radial slot 11. After the lever is removed, the VC 20 continues to have a stress force sufficient to clamp/affix a pipe or a cylindrical tube to a rigid support structure. In accordance with the method of this invention, the conduit hole 14 is required to have an Inner Diameter (ID) slightly less than the Outer Diameter (OD) of a conduit to be inserted therein with the VC 20 which has an ID slightly less the than the OD specification of a standard tube or pipe. When the lever is removed from the radial slot 11 the VC 20 rigidly grips the conduit inserted therein.

FIG. 2D shows a rotated plan view of the VC 20 of FIG. 2A with the radial slot 11 on the right extending out from the conduit hole 14 and four fastener holes 16 extending through the flange 15. FIG. 2E shows the obverse side of the VC of FIG. 2D with the back end 13 of the boss 17 surrounding the conduit hole 14 and the back 19 of the flange 15 surrounding the boss 17.

FIG. 2F shows an inverted, elevation of the VC 20 of FIG. 2D with the radial slot 11 on the right and on the edge of the flange 15. The back end 13 of the boss 17 and the back of the flange 15 are shown. FIG. 2G is a sectioned, inverted elevation taken along section line 2G-2G in FIG. 2E through the central axis of the VC 20.

### Invisible Escutcheon Clamp (IEC)

The Invisible Escutcheon Clamp (IEC) is preferably a flexible plastic model of a conduit clamp in accordance with this invention with or without mounting holes on the flange and an adhesive previously present or currently applied to the reverse (boss (17)) side of the flange. A wedge or screwdriver is inserted into the split area to expand the center hole in order to enable the clamp to slide over the tube or pipe. Once the clamp is near the correct position, the reverse side of the clamp is pressed onto the barrier so that the glue which is exposed bonds the flange and the clamp to the barrier. Mounting screws may also be applied. After the pipe or tube is adjusted to the desired position, the wedge is removed. An escutcheon plate is then positioned over the clamp to conceal it, making it “invisible”.

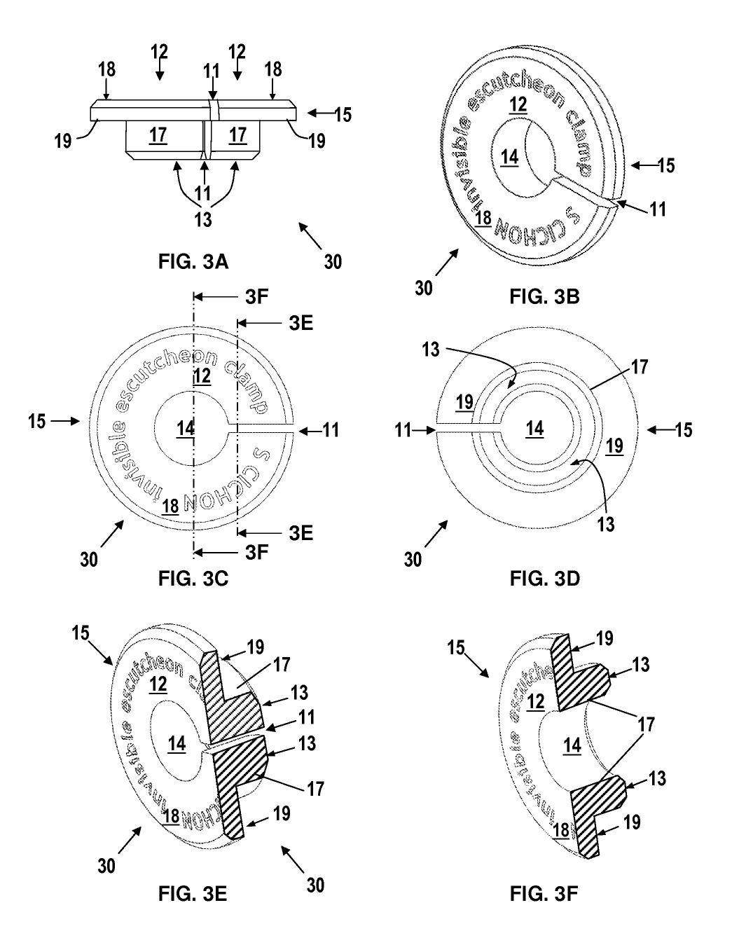

FIGS. 3A-3F show an IEC 30 for a conduit in accordance with this invention. FIG. 3A is a side elevation of the IEC 30 with the clamp plate 12 which is disk shaped on top with a round flange 15 on the margin thereof. As in FIGS. 1A-1D, FIG. 3B shows the clamp plate 12 is the front end of IEC 30 with the boss 17 below the clamp plate 12. The back end 13 of the boss 17 is shown in FIG. 3D. The IEC 30 is a flexible plastic model s without mounting holes through the flange 15 and which has adhesive or glue (not shown) applied to the back side 19 of the flange 15. Mounting hole can be added to the IEC 30. As in FIGS. 1A-1D. and 2A-2G, a pipe or tube is to be installed into the IEC 30 by inserting a wedge or screwdriver (or the like) into the radial slot 11 (the split area) to expand the center hole 14 in order to enable the IEC 30 to slide over the pipe or tube. Once the IEC 30 is near the correct position, the adhesive or glue on the back 19 of the flange 15 is exposed and the IEC 30 is pressed firmly against a barrier as in FIGS. 1C and 1D. Alternatively, mounting screws may also be applied through holes through the flange 15. After the pipe or tube is adjusted to the desired position, the wedge or screwdriver is removed. A conventional escutcheon plate (not shown) is then positioned over the clamp to conceal it, making it “invisible”.

### Hose Bib Clamp (HBC)

The Hose Bib Clamp (HBC) is a flexible, heat-resistant plastic or stamped metal structure with a larger flange than for the Visible Tube Clamp (VTC). The flange can be any shape or size and may have one or more mounting holes. The plastic version is used with pipes or tubes that have threads (in the case of black iron pipes for instance) or compression fittings (copper, stainless steel, or brass pipes) that are not subject to excessive heat. The stamped metal version is for pipes or tubes that may have fittings soldered or welded nearby.

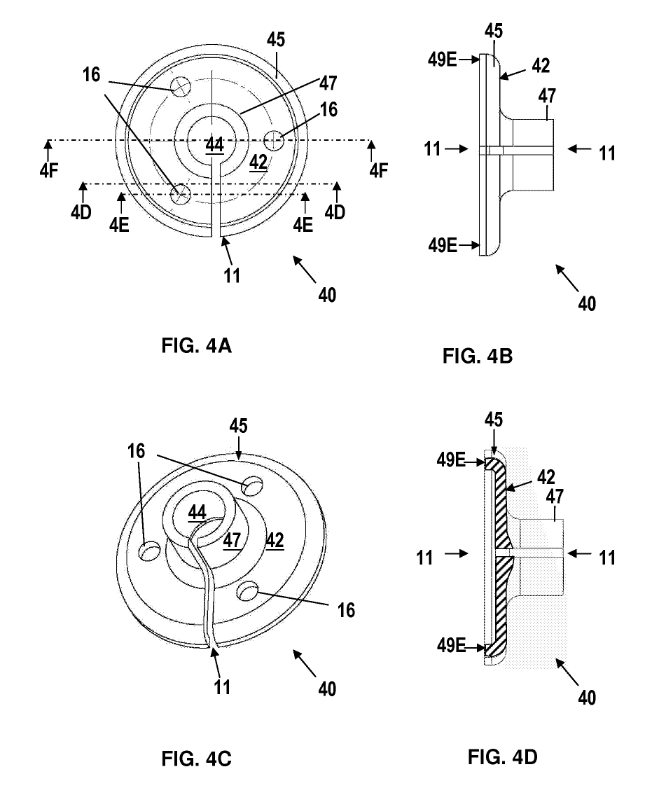

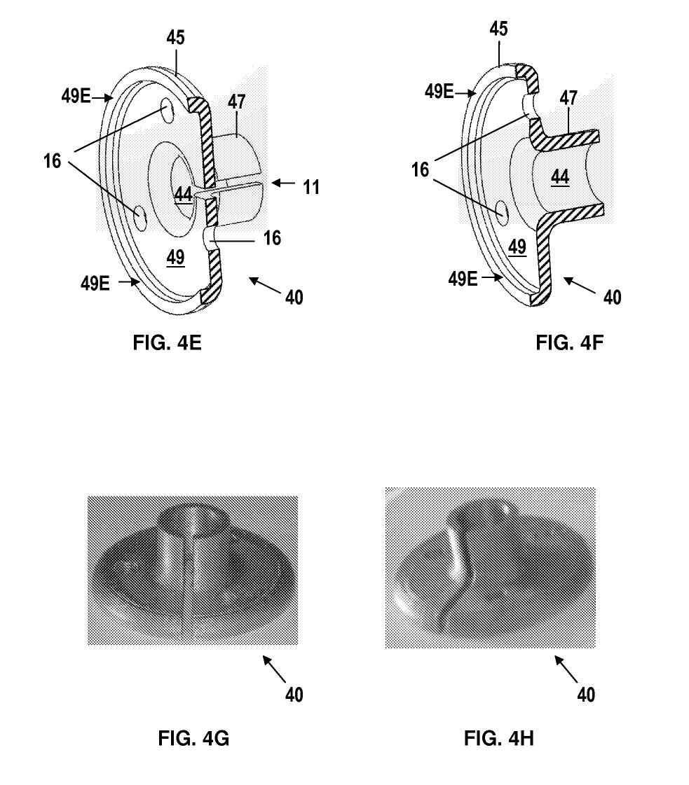

FIGS. 4A-4H show views of a Hose Bib Clamp (HBC) 40 in accordance with this invention. FIG. 4A shows a view of the obverse side of the HBC 40 with the radial slot 11 at the bottom The HBC 40 is a heat-resistant flexible plastic or stamped metal version of a tube clamp with a front boss 47 and an HBC flange 45 which is shown to be relatively larger than the flanges described above. The HBC flange 45 can be any shape or size, and has a conduit hole 44 and may have one or more mounting holes 16 through its flange 45 as shown in several of the drawings. The HBC 40 is installed with fasteners or with adhesive. FIG. 4B shows a left elevation of the HBC 40 with the radial slot 11 rotated to the front surface. FIG. 4C is a perspective view of the obverse side of the HBC 40 with the front boss 47 shown clearly. FIG. 4D is a sectioned left elevation of the HBC 40 taken along line 4D-4D in FIG. 4A. FIG. 4E is a sectioned, perspective view of the obverse side of the HBC 40 taken along line 4E-4E in FIG. 4A. FIG. 4F is a sectioned, perspective view of the obverse side of the HBC 40 taken along line 4F-4F in FIG. 4A. FIGS. 4G and 4H are photographs of the obverse side of a model of an HBC 40. As stated above, the plastic version of the HBC flange 40 is adapted for use with pipes or tubes that have threads (in the case of black iron pipes for instance) or compression fittings (copper, stainless steel, or brass pipes) that are not subject to excessive heat. The stamped metal version of the HBC flange 45 is adapted for use with pipes or tubes that may have fittings soldered or welded nearby.

### Matching Plastic SQuare (MPSQ) Tube Clamp

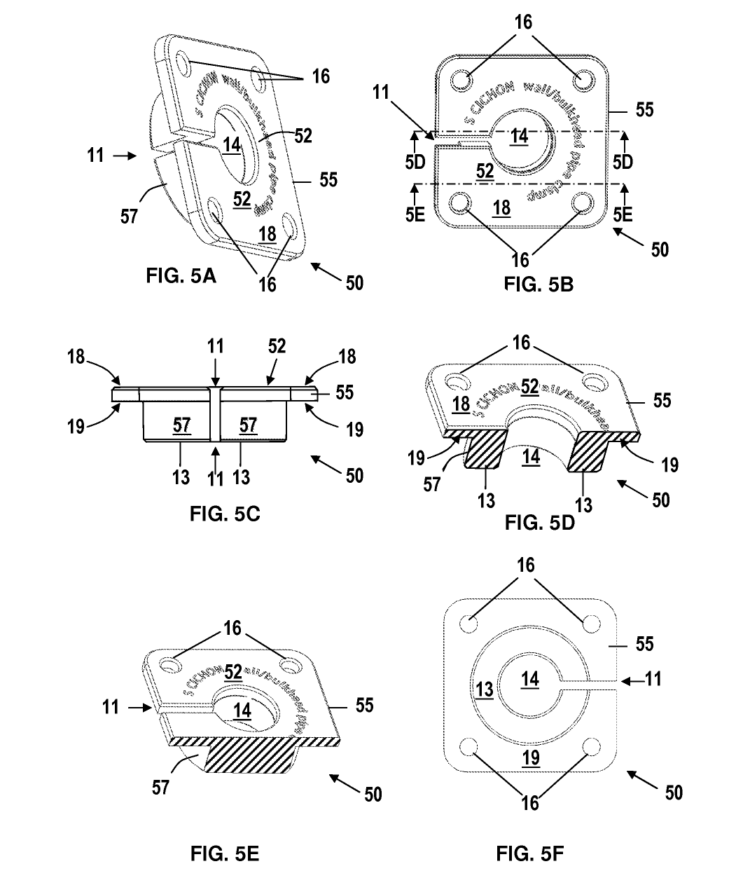

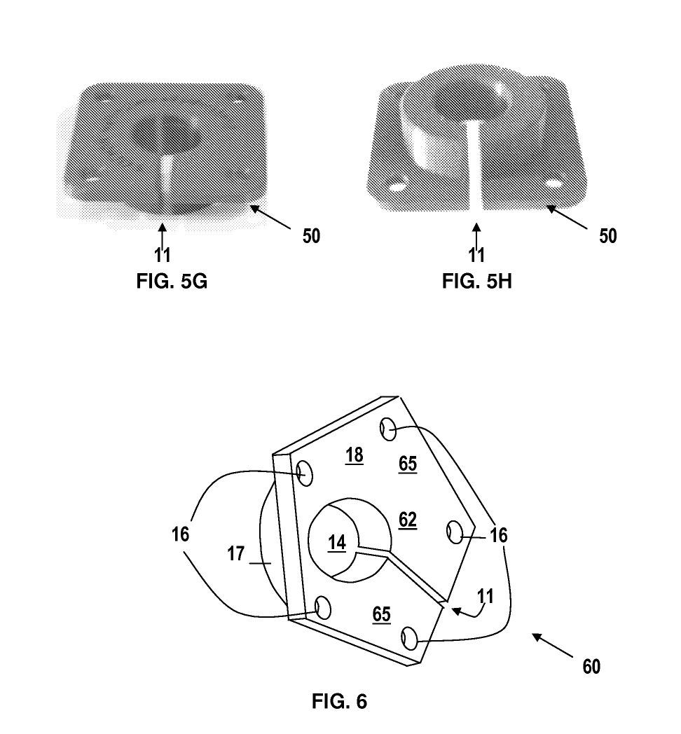

FIGS. 5A-5H show views of a Matching Plastic SQuare (MPSQ) tube clamp 50 in according to this invention. FIG. 5A is a perspective view of MPSQ tube clamp 50, that is preferably composed of the same type of plastic as the plastic conduit it is intended to support. The MPSQ tube clamp 50 has a flat, thin, wide and square, hollow clamp plate 52, in front and a hollow cylindrical boss 57 in the back, which is integral with the clamp plate 52 and narrower than the clamp plate 52. FIG. 5A shows the clamp plate 52 with a square flange 55 rounded corners for illustration, but the MPSQ clamp 50 can be of any size or shape. The rounded corners are juxtaposed with four fastener holes 16 that extend through of the flange 55. As in the previous embodiments of this invention, the tube clamp 50 includes the radial slot 11 and the central conduit hole 14, which are described above. FIG. 5B is a plan view of the obverse side of the tube clamp 50. FIG. 5C is a left elevation of FIG. 5B showing the radial slot 11 in front, indicating the location of back 13 of the boss 17 on the bottom and also indicating the back 19 of the clamp flange 55. FIG. 5D is a sectioned view of the obverse side of the clamp 50 taken along line 5D-5D in FIG. 5B showing half of the tube and pipe hole 14; and which shows the solid structure of the clamp 50. FIG. 5E is a sectioned view of the obverse side of the clamp 50 taken along line 5E-5E in FIG. 5B which also shows the solid structure of the clamp 50. FIG. 5F shows the reverse side of the view of the clamp 50 in FIG. 5B. FIGS. 5G and 5H are photographs views of the obverse side and the reverse side respectively of a model of the clamp 50. Plastic conduit clamp 50 has a large flange 55 with a thicker boss 57 for additional support made of the same type of plastic as the pipe or tube it is intended to support (such as PVC). The difference between this version and those above is that the center of the boss 57 is not undersized and the clamping force is achieved by a chemical bond generated by the appropriate glue or bonding agent applied between the inner boss surface and the outer surface of the pipe or tube which is bonded thereto and held in position when it is assembled in place. In this case, a wedge or screwdriver is not necessary to open the MPSQ clamp 50.

### Pentagonal Conduit Tube (PCT) Clamp

FIG. 6 is a perspective view of a Pentagonal Conduit Tube (PCT) clamp 60 with a pentagonal clamp plate 62 on the obverse side which includes a pentagonal flange 65 with fastener holes 16 proximate to the five corners of flange 65 and a cylindrical boss 67 on the reverse side of the PCT clamp 60. The conduit hole 14 of the PCT clamp 60 is at an angle such as 10, 20 or 30 degrees with respect to the surface of the clamp plate 62 and the pentagonal flange 65 as well as any barrier surfaces into which the boss 17 thereof is to be inserted.

### Bonding Materials

Adhesive tapes for bonding surface of clamp flange are preferably a die cut adhesive tape that can be applied during manufacture with a peel off paper backing that can be removed at the point of use (in the field). Such tapes include 3M Company products such as VHB tape 4941 Double coated conformable acrylic foam, multi-purpose acrylic adhesive, closed cell, gray for use with Primer 94. 3M™ Tape Primer 94 and VHB tape 5952 Double coated very conformable acrylic foam, modified acrylic adhesive, closed cell, black for use with 3M™ Primer 94. The 3M™ Tape Primer 94 is an adhesion promoter for use in conjunction with 3M™ VHB™ Tapes. It is a durable adhesion promoter useful for priming and promoting adhesion for use on many plastic, rubber, painted and bare metal substrates. 3M™ VHB™ Tape's 100% acrylic closed cell construction bonds metals, plastics and glass eliminating the need for screws, rivets, welds and other mechanical fasteners in many applications. Fast, easy to use and reliable, VHB tapes help improve styling, performance and productivity. Foam conforms to many irregular surfaces. Alternatives are double coated tape 9495LE or 9500PC. 3M™ Double Coated Tape 9495LE 6.7 mil 300LSE low surface energy acrylic adhesive on a polyester film carrier with a 4.2 mil 58 lb polycoated kraft paper liner is for use on low surface energy surfaces and as plastic extrusion attachment. Double coated version of 3M Adhesive Transfer Tape 9472LE. Improved handling and ease of die-cutting. Another alternative is 3M™ Double Coated Tape 9500PC is a 5.6 mil 350 high performance acrylic adhesive double coat with polyester carrier on a 4.5 mil 61.5 lb polycoated kraft paper liner. It is a 2.0 mil polyester carrier for improved dimensional stability for use to laminate high performance plastics and difficult substrates.

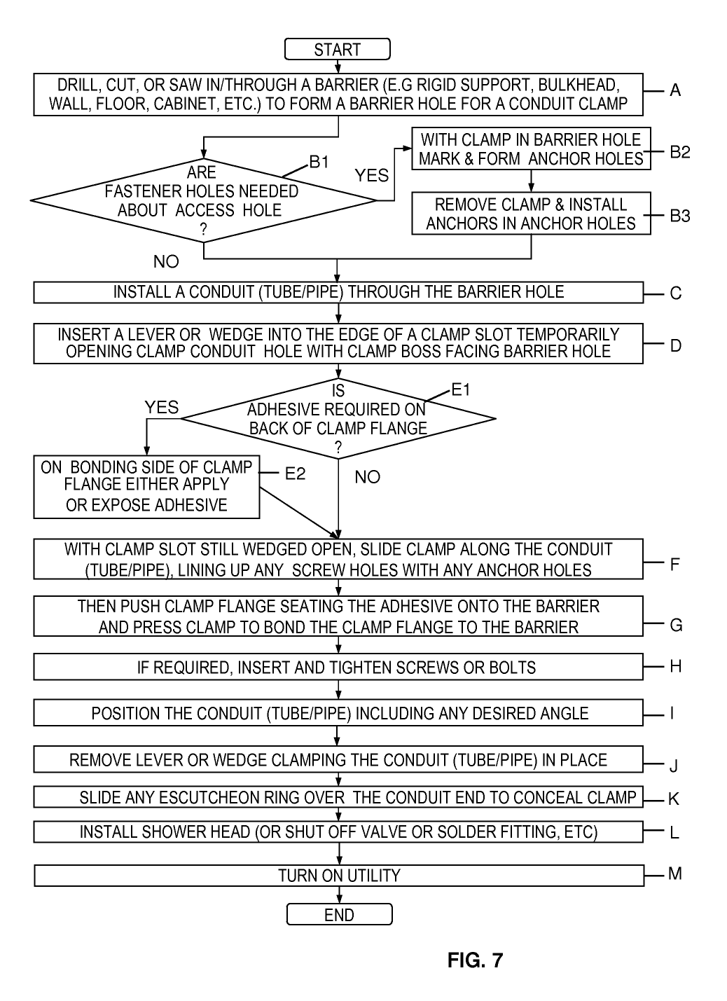

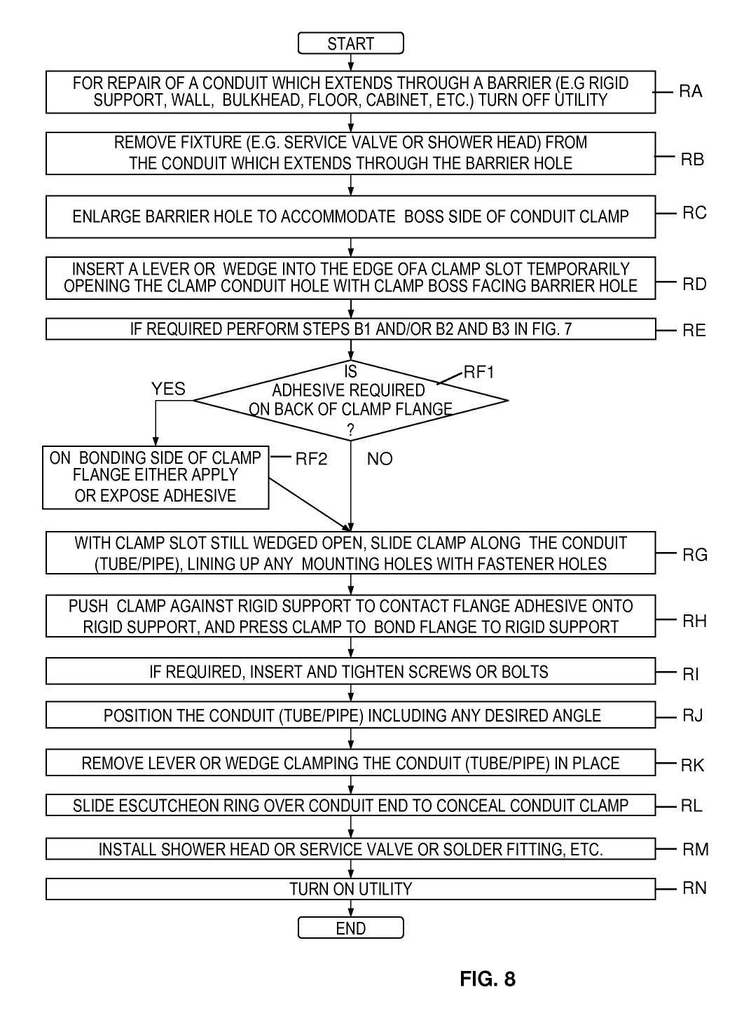

Alternative sequences of process steps are required for the diverse tasks that can be performed using a clamp of this invention. FIG. 7 shows a flow chart of all process steps for various new construction applications. The tables below reference the steps needed to produce the required result each application.

Method of Installation of Conduit Clamp in New Construction

| | |
|---|---|
| START | |
| STEP A | Drill, cut, or saw in/through a barrier 22 (e.g. rigid support, bulkhead, wall, floor, |
| | cabinet, etc.) to form a barrier hole 23 for the tube 24 (pipe of installing tubes or |
| | pipes in pipe clamps. In other words, to install the Invisible Escutcheon Clamp |
| | 20, first trim around the barrier hole 23 with a knife or saw enough to allow the |
| | boss on the back of the clamp to pass into the surface of the barrier 22 (e.g. a |
| | wall or bulkhead. Referring to steps B1-B3 below, at this time, if the clamp 10, |
| | 20, etc. is equipped with mounting holes 16, a template may be used to mark |
| | hole locations on the barrier 22 and anchors may be inserted in their proper |
| | positions around the perimeter of the barrier hole 23. |
| STEP B1 | Are fastener holes needed about the access hole? If YES go to step B2. |
| | If NO go to step C. |
| STEP B2 | With the clamp in barrier hole mark & form anchor holes and go to step B3. |
| STEP B3 | Remove the clamp 10, install anchors in anchor holes in barrier & go to step C. |
| STEP C | Install a conduit 24 through a barrier hole 23. |
| STEP D | Insert a wedge (screwdriver) into edge of clamp slot 11 to open clamp hole 14 |
| | with clamp boss 17 facing barrier hole 23 as wedge expands hole 14 enough to |
| | allow clamp 10 to fit over the end of pipe 24, leaving the wedge in place for now. |
| STEP E1 | Is adhesive required on back of the clamp flange? If YES go to step E2? |
| | If NO go to step F. |
| STEP E2 | Expose adhesive on bonding side of clamp flange or apply adhesive to bonding |
| | side of clamp flange |
| STEP F | With clamp slot still wedged open, slide clamp along the tube or pipe. Line up |
| | any screw holes with any anchor holes. Slide clamp over end of the (line up the |
| | mounting holes) and push adhesive coated side of flange towards barrier until |
| | on flange contacts barrier surface. |
| STEP G | Push clamp flange until the adhesive seats on the barrier and then press the clamp |
| | to bond the clamp flange to the barrier. |
| STEP H | If required, insert and tighten screws or bolts. |
| STEP I | Position the tube including any desired angle in the case of a bent shower head |
| | only. Other applications will most likely be straight although it is conceivable |
| | that the clamp may be produced with the center hole at any angle up to 45 degrees |
| | and still maintain structural integrity) and remove the screwdriver or wedge. |
| STEP J | Remove lever or wedge clamping the conduit in place |
| STEP K | Slide any escutcheon ring over the tube end to conceal the clamp. |
| STEP L | Install the shower head (or a shut off valve or a solder fitting, etc. |
| STEP M | Turn on the utility |
| END | |

New Construction Installation of Conduit Clamp in a Finished Wall—Plastic/Iron (Cold Installations)

| | |
|---|---|
| START | |
| STEP A | cut hole in barrier slightly larger than clamp boss |
| STEP C | install pipe through hole in barrier |
| STEP D | insert wedge into clamp slot and slide over pipe |
| | with boss facing barrier hole |
| STEP E1-E2 | remove adhesive backing or apply adhesive on |
| | back of clamp flange |
| STEP G | push clamp against wall to seat adhesive |
| STEP I | position pipe |
| STEP J | remove wedge |
| STEP K | slide escutcheon ring over pipe to conceal clamp |
| | L install shower head or service valve. |

New Construction Installation of Conduit Clamp Utility—Plastic/Iron (Cold Installations)

| | |
|---|---|
| START | |
| STEP A | cut hole in barrier slightly larger than clamp boss |
| STEP B1-B2 | position clamp in barrier hole and mark anchor locations |
| STEP B3 | remove clamp and install wall anchors |
| STEP D | insert wedge into clamp slot and slide over pipe with |
| | boss facing barrier hole |
| STEP E2 | remove adhesive backing/apply adhesive on back of |
| | clamp flange (if applicable) |
| STEP F | push clamp against wall to seat adhesive (if applicable) |
| | making sure flange holes align with wall anchors |
| STEP H | install wall anchor screws |
| STEP I | position pipe |
| STEP J | remove wedge |
| STEP K | not applicable |
| STEP L | install shower head or service valve |

New Construction Installation of Conduit Clamp Utility—Plastic/Iron (Cold Installations) Floor Or Ceiling

| | |
|---|---|
| STEP | START |
| A | cut hole in barrier slightly larger than pipe diameter |
| B2 | position clamp in barrier hole and mark anchor locations |
| B3 | remove clamp and install wall anchors |
| C | install pipe through hole in barrier |
| D | In a modification of step D, insert wedge into clamp slot and |
| | slide over pipe with boss facing AWAY FROM barrier hole |
| E1-E2 | Not applicable but one may apply adhesive to FRONT of |
| | clamp flange |
| G | push clamp against wall to seat adhesive (if applicable) |
| | making sure flange holes align with wall anchors |
| H | install wall anchor screws |
| I | position pipe |
| J | remove wedge |
| K | not applicable |
| L | install shower head or service valve |

New Construction Installation of Conduit Clamp Utility—Copper (Hot Installations) Stamped Metal Pipe Clamp

| | |
|---|---|
| 0 | START |
| A | cut hole in barrier slightly larger than pipe diameter |
| B2 | position clamp in barrier hole and mark anchor locations |
| B3 | remove clamp and install wall anchors |
| C | install pipe through hole in barrier |
| D′ | In a modification of step D insert wedge into clamp slot and |
| | slide over pipe with boss facing AWAY FROM barrier hole |
| E1-E2 | Not applicable |
| F | Slide clamp into position taking care to align flange holes |
| | align with wall anchors |
| H1 | Install wall anchor screws |
| I | Position pipe |
| J | Remove wedge |
| K | not applicable |
| L | install shower head or service valve |

Below are several tables relating to repair applications providing clamps for supporting a conduit in a repair application instead of new construction application. The steps RA-RN in the tables refer to some or all of the process steps shown in the flow chart of FIG. 8 as required for a particular repair application. Reference is also made to steps B1-B3.

Conduit Clamp with a Finished Wall (Plastic/Iron (Cold Applications)

| | |
|---|---|
| Step | START |
| RA | First turn off utility for a repair of a previous installation of a conduit which |
| | extends through a barrier (e.g. rigid support, wall, bulkhead, floor, cabinet, etc.) |
| RB | Remove fixture (e.g. service valve or shower head) from the conduit which |
| | extends through the barrier hole. |
| RC | Enlarge barrier hole to accommodate the boss side of the tube clamp |
| RD | Insert a lever or wedge into the edge of clamp slot temporarily opening the clamp |
| | tube hole with clamp boss facing barrier hole |
| RE | If required perform steps B1 and/or B2 and B3 in FIG. 7 which are as follows: |
| B1 | Are fastener holes needed about the access hole? If YES go to FIG. 7 step B2. |
| FIG. 7 | If NO go to step RF1. |
| B2 | With the clamp in barrier hole mark positions for anchor holes. |
| FIG. 7 | Then form the anchor holes and go to step B3. |
| B3 | Remove the clamp 10; install anchors in anchor holes in barrier; go to |
| FIG. 7 | step RF1. |
| RF1 | Is adhesive required on the back of the clamp flange? If YES go to step RF2. |
| | If NO go to step RG. |
| RF2 | Apply adhesive to bonding side of clamp flange and go to step RG; or expose |
| | adhesive on bonding side of clamp flange and go to step RG. |
| RG | With clamp slot still wedged open, slide clamp along the tube or pipe, lining up |
| | any screw holes with any anchor holes |
| RH | Push clamp to seat the adhesive onto the barrier. Then press the clamp to bond the |
| | clamp flange to the barrier. |
| RI | If required, insert and tighten screws or bolts. |
| RJ | Position the pipe or tube including any desired angle. |
| RK | Remove lever or wedge clamping the conduit in place. |
| RL | Slide any escutcheon ring over the tube end to conceal the clamp. |
| RM | Install the shower head (or a shut off valve or a solder fitting, etc.) |
| RN | Turn on the utility. |
| | END |

Finished Wall—Plastic/iron (Cold Applications)

| | |
|---|---|
| Step | START |
| RA | First turn off utility for a repair of a previous installation of a conduit |
| | which extends through a barrier (e.g. rigid support, wall, bulkhead, |
| | floor, cabinet, etc.) |
| RB | Remove fixture (e.g. service valve or shower head) from the conduit |
| | which extends through the barrier hole. |
| RC | Enlarge barrier hole to accommodate the boss side of the tube clamp |
| RD | Insert a lever or wedge into the edge of clamp slot temporarily |
| | opening the clamp tube hole with clamp boss facing barrier hole |
| RF1 | Is the adhesive on the back of the clamp flange? If YES go to step |
| | RF2. If NO go to step RG. |
| RF2 | Apply adhesive to bonding side of clamp flange and go to step RG; |
| | or expose adhesive on bonding side of clamp flange and go to step |
| | RG |
| RG | With clamp slot still wedged open, slide clamp along the tube or pipe. |
| RH | Push clamp to seat the adhesive onto the barrier. Press the clamp to |
| | bond the clamp flange to the barrier. |
| RJ | Position the pipe or tube including any desired angle for a shower |
| | head |
| RK | Remove lever or wedge clamping the conduit in place |
| RL | Slide an escutcheon ring over the pipe or tube end to conceal the |
| | clamp |
| RM | Install the shower head or shut off valve |
| RN | Turn on the utility. |
| | END |

Utility—Plastic/Iron (Cold Installations)

| | |
|---|---|
| Step | START |
| RA | First turn off utility for a repair of a previous installation of a conduit |
| | extending through a barrier (e.g. rigid support, wall, bulkhead, floor, |
| | cabinet, etc.) |
| RB | Remove fixture (e.g. service valve or shower head) from the conduit |
| | which extends through the barrier hole. |
| RC | Enlarge barrier hole to accommodate the boss side of the clamp |
| RD | Insert a lever or wedge into the edge of clamp slot temporarily |
| | opening the clamp tube hole with clamp boss facing the barrier hole. |
| RD1 | Slide clamp to wall and mark anchor holes. Remove clamp and |
| | mount wall anchors. Slide clamp back onto the tube or pipe |
| RF1 | Is the adhesive on the back of the clamp flange? If YES go to step |
| | RF2. If NO go to step RG. |
| RF2 | Apply adhesive to bonding side of clamp flange and go to step RG; |
| | or Expose adhesive on bonding side of clamp flange and go to step |
| | RG. |
| RG | With clamp slot wedged open, slide clamp along the tube or pipe. |
| RH | Push clamp to seat the adhesive on the barrier. Press the clamp to |
| | bond the flange to the barrier taking care to align flange holes with |
| | wall anchors. |
| RJ | Position the pipe or tube including any desired angle for a shower |
| | head |
| RK | Remove lever or wedge clamping the conduit in place |
| RM | Install the shower head or shut off valve |
| RN | Turn on the utility. |
| | END |

Utility—Plastic/Iron (Cold Installations) Floor or Ceiling

| | |
|---|---|
| Step | START |
| RA | First turn off utility for a repair of a previous installation of a conduit |
| | extending through a barrier (e.g. rigid support, wall, bulkhead, floor, |
| | cabinet, etc.) |
| RB | Remove fixture (e.g. service valve or shower head) from the conduit |
| | which extends through the barrier hole. |
| RD | Insert a lever or wedge into the edge of clamp slot temporarily |
| | opening the clamp tube hole with clamp boss facing AWAY from |
| | floor or ceiling. |
| RD1 | Slide clamp to floor or ceiling wall and mark anchor holes. Remove |
| | clamp and mount wall anchors. Slide clamp back onto the tube or |
| | pipe. |
| RF1 | Is the adhesive on the back of the clamp flange? If YES go to step |
| | RF3. If NO go to step RF2. |
| RF2 | Apply adhesive to front bonding side of clamp flange and go to step |
| | RG; or expose adhesive on bonding side of clamp flange and go to |
| | step RG |
| RG | With clamp slot still wedged open, slide clamp along the tube or pipe. |
| RH | Push clamp to seat the adhesive on the barrier. Press the clamp to |
| | bond the flange to the barrier taking care to align flange holes with |
| | wall anchors. |
| RJ | Position the pipe or tube to desired depth. |
| RK | Remove lever or wedge clamping the conduit in place |
| RL | Slide an escutcheon ring over the pipe or tube end to conceal the |
| | clamp |
| RM | Install the service valve or shut off valve |
| RN | Turn on the utility. |
| | END |

Utility—Conner (Hot Installations) Stamped Metal Pine Clamp

| | |
|---|---|
| Step | START |
| RA | First turn off utility for a repair of a previous installation of a |
| | conduit extending through a barrier (e.g. rigid support, wall, |
| | bulkhead, floor, cabinet, etc.) |
| RB | Remove fixture (e.g. service valve or shower head) from the |
| | conduit which extends through the barrier hole. |
| RD | Insert a lever or wedge into the edge of clamp slot temporarily |
| | opening the clamp tube hole with clamp boss facing AWAY |
| | from floor or ceiling. |
| RD1 | Slide clamp to floor or ceiling wall and mark anchor holes. |
| | Remove clamp and mount wall anchors. Slide clamp back |
| | onto the tube or pipe. |
| RG | With clamp slot still wedged open, slide clamp along the tube |
| | or pipe. |
| RH | Push clamp to seat it on the barrier taking care to align flange |
| | holes with wall anchors. |
| RJ | Position the pipe or tube to desired depth. |
| RK | Remove lever or wedge clamping the conduit in place; and |
| | the metal conduit may be soldered for added rigidity. |
| RM | Install the service valve or shut off valve |
| RN | Turn on the utility. |
| | END |

Repair of Utility—Plastic/Iron (Cold Instillations)

| | |
|---|---|
| RA | For repair of a tube (pipe) which extends through a barrier (e.g. |
| | rigid support, wall, bulkhead, floor, cabinet, etc.) turn off utility |
| RB | RB Remove fixture (e.g. service valve or shower head) from the |
| | conduit which extends through the barrier hole. |
| RC | Enlarge barrier hole to accommodate the boss side of the tube |
| | clamp |
| RD | Insert a lever or wedge into the edge of clamp slot temporarily |
| | opening the clamp tube hole with clamp boss facing barrier hole |
| B1 | Slide clamp up to barrier and mark anchor holes |
| FIG. 7 | |
| B2 | With the clamp in barrier hole mark positions for anchor holes. |
| FIG. 7 | Then form anchor holes and go to step B3. |
| B3 | Remove the clamp 10. |
| FIG. 7 | The install anchors in anchor holes in the barrier. |
| RF1 | Apply adhesive to bonding side of clamp flange and go to step |
| | RG. |
| RF2 | Expose adhesive on bonding side of clamp flange and go to step |
| | RG. |
| B3 | Expose adhesive on bonding side of clamp flange and go to step |
| | RG. |
| RF | |
| RG | With clamp slot still wedged open, slide clamp along the tube or |
| | pipe, lining up any screw holes with any anchor holes |
| RH | Then push clamp flange seating the adhesive onto the barrier and |
| | then press the clamp to bond the clamp flange to the barrier |
| RI | If required, insert and tighten screws or bolts |
| RJ | Position the tube including any desired angle |
| RK | Remove lever or wedge clamping the conduit in place |
| RL | Slide any escutcheon ring over the tube end to conceal the clamp |
| RM | Install the shower head (or a shut off valve or a solder fitting, etc.) |
| RN | Turn on the utility. |
| | END |

While a frequent application of the conduit clamp of this invention is for use with a shower head, other common uses would be hot/cold water supply lines to sinks, dishwashers, and ice machines. In addition, clamps in accordance with embodiments of this invention can be used on electrical conduits going through walls, floors, and ceilings.

Another application would be to use the conduit clamp to form a seal against air, insects, etc. from entering the space between a conduit and a barrier.

Still another application is to position a bent or curved conduit at a desired angle after affixing the conduit clamp to the barrier.

The plate 12 and flange 15 of the clamp 10 may be asymmetrical in the sense of that the plate 12 of the clamp 10 of FIG. 1 or other embodiments may be rectangular, elliptical, etc. with the flange 15 including provision for structural support by adhesive or with fastener holes which are aside from the conduit hole 14. In the case of such an asymmetrical plate 12 and flange 15 the clamp can be mounted under, over or aside from the structural support, when required.

### Specifications for Clamp Materials

The conduit clamps in accordance with this invention are preferably composed of polypropylene, HDPE, PVC, or metal for damp locations. It has approximately 3 square inches of contact area and may be used indoors or outdoors. It will need to withstand temperatures up to 160 degrees Fahrenheit, 5 pounds of shear load and an occasional load of up to 20 pounds in tension.

The foregoing description discloses only exemplary embodiments of the invention. Modifications of the above disclosed apparatus and methods which fall within the scope of the invention will be readily apparent to those of ordinary skill in the art. While this invention is described in terms of the above specific exemplary embodiment(s), those skilled in the art will recognize that the invention can be practiced with modifications within the spirit and scope of the appended claims, i.e. changes can be made in form and detail, without departing from the spirit and scope of the invention. Accordingly, while the present invention is disclosed in connection with exemplary embodiments thereof, it should be understood that changes can be made to provide other embodiments which may fall within the spirit and scope of the invention and all such changes come within the purview of the present invention and the invention encompasses the subject matter defined by the following claims.

What is claimed is:

1. A clamp (10) for clamping a conduit or pipe with the clamp (10) having a given Outer Diameter (OD) and having a cylindrical outer surface comprising:
the clamp (10) including a clamp plate (42) with an exterior, front surface (18) at one end of the clamp (10) and with a boss (47) formed with an exterior, opposite surface (13) at an opposite end of the clamp (10);
the clamp plate (42) being formed with a peripheral flange (15) which shares the front surface (18) on the one end,
the peripheral flange (15) having a second surface (19) behind and peripheral with respect to the front surface (18), with the flange (15) having a minimum OD;
the boss (17) being formed integral with the clamp plate (12);
the boss (17) being narrower outer dimension than the minimum OD of the flange (15);
a cylindrical, central, through hole (14) which extends lengthwise completely through the clamp (10) from the front surface (18) of the clamp plate (12) and through the second surface (19) of the boss (17);
the through hole (14) having a cylindrical interior surface with an Inner Diameter (ID) smaller than the outer dimension of the boss (17);
the clamp (10) including a radial slot extending outwardly from the ID of the through hole (14) through the boss (17) and outwardly through the flange (15) from the OD of the through hole (14) to peripheral edges of the boss (17) and the plate; and
the through hole (14) having a cylindrical ID slightly less than the given OD of a conduit or pipe to be inserted therein.

2. The clamp of claim 1 wherein the shape of the flange (15) is polygonal (65), or round (45).

3. The clamp of claim 1 wherein the clamp (10) is composed of a flexible material such as plastic or a metal stamping that will hold a conduit by means of tension.

4. The clamp of claim 1 wherein at least one fastener hole (16) is formed extending through the flange (15) from the first surface (18) to the second surface (19).

5. The clamp of claim 1 wherein:
the back surface (19) of the flange (15) is behind the first surface (18); and
a fastener hole is formed extending through the peripheral flange (15).

6. The clamp of claim 1 including adhesive material (26) formed on the opposite surface (19) of the flange (15).

7. The clamp of claim 2 wherein the through hole (14) is formed at an angle to the central axis.

8. The clamp of claim 2 wherein at least one fastener hole (16) is formed extending through the flange (15) from the first surface (18) to the opposite surface (19).

9. The clamp of claim 2 wherein:
the opposite surface (19) of the flange (15) is behind the front surface; and
a fastener hole is formed extending through the peripheral flange (15

10. The clamp of claim 2 including adhesive material (26) formed on the opposite surface (19) of the flange (15).

11. A clamp (40) for clamping a conduit or pipe with the clamp (40) having a given Outer Diameter (OD) and having a cylindrical outer surface comprising:
the clamp (40) including a clamp plate (42) with a boss (47) extending forward from the clamp plate (42);
the clamp plate (42) being formed with a peripheral flange (45) having a minimum OD;
the boss (47) being formed integral with the clamp plate (42);
the boss (47) having an outer dimension smaller than the minimum OD of the flange (45);
a cylindrical, central, through hole (44) which extends lengthwise completely through the clamp (40) including the clamp plate (42) and the boss (47);
the through hole (44) having a cylindrical interior surface with an Inner Diameter (ID) smaller than the outer dimension of the boss (47);
the clamp (40) including a radial slot extending outwardly from the ID of the through hole (44) through the boss (47) and outwardly through the flange (45) from the OD of the through hole (44) to peripheral edges of the boss (47) and the clamp plate (42); and
the through hole (44) having a cylindrical Inner Diameter (ID) slightly less than the given OD of a conduit or pipe to be inserted therein.

12. The clamp of claim 11 wherein at least one fastener hole (16) is formed extending through the flange (45).

13. The clamp of claim 11 wherein the clamp (40) is composed of a material selected from the group consisting of heat resistant flexible plastic or a stamped metal.

14. The clamp of claim 11 wherein the clamp (40) is composed of a flexible material selected from the group consisting of a plastic or a metal stamping adapted to hold a conduit by means of tension.
